(19) United States
(12) Patent Application Publication
(10) Pub. No.: US 2023/0050230 A1
(43) Pub. Date: Feb. 16, 2023

(54) INTERFEROMETRIC FIBER-OPTIC GYROSCOPE WITH REDUCED COMMON MODE PHASE NOISES AND POLARIZATION CROSSTALK FOR ENHANCED MEASUREMENT SENSITIVITY AND ACCURACY

(71) Applicants: Chi-Luen Wang, Taipei City (TW); Ju-Tah Tung, New Taipei City (TW)

(72) Inventors: Chi-Luen Wang, Taipei City (TW); Ju-Tah Tung, New Taipei City (TW)

(21) Appl. No.: 17/398,470

(22) Filed: Aug. 10, 2021

(51) Int. Cl. G01C 19/72; G02B 6/28

(52) U.S. Cl. CPC G01C 19/725; G02B 6/2843

(57) ABSTRACT

An improved-type of interferometric fiber-optic gyroscope (FOG) is proposed, which is used for the observation and measurement of the Sagnac effect to determine the angular speed of a rotational movement with enhanced measurement sensitivity and accuracy. The improved FOG is characterized by the combined use of a polarization-maintaining mechanism, a symmetric beam-splitting configuration for the 3×3 directional coupler, a common optical path for the opposing beams, and a pair of photo detectors for the detection of a pair of differential phase signals that indicate the angular speed of the rotational movement. The combined use of these approaches can help significantly eliminate and reduce the common mode phase noises caused by polarization crosstalk to a minimum possible level that has never been achieved by the conventional FOGs, thus significantly enhancing the measurement sensitivity and accuracy to a much higher level.

### BACKGROUND OF THE INVENTION

### 1. Field of the Invention

The invention relates to fiber-optic gyroscope (FOG) technology, and more particularly to an improved type of interferometric fiber-optic gyroscope which is specifically designed for the purpose of eliminating and reducing the common mode phase noises that would be otherwise caused by polarization crosstalk to thereby enhance the sensitivity and accuracy in the observation and measurement of the Sagnac effect for more precise detection of the angular speed of a rotational movement.

### 2. The Prior Art

Fiber-optic gyroscope (FOG) technology has been utilized in various industrial, defense and automobile sector for the last few decades. It has been proven to be one of the most reliable instruments in navigation and guidance. Although the GPS (global positioning system) technology can also be used to pinpoint a location accurately, typically within an error of less than one meter, one drawback of the GPS technology, however, is that it relies on constant satellite signals as reference such that its use and application is considerably complex and costly to implement. Therefore, there still exists a great demand of redundancy in addition to the GPS system, especially in signaling down time or dead zones. In fact, the only solution currently available for dead-reckoning navigation between the usually sparse well-reckoned points is to use inertial sensors such as fiber gyros and accelerometers.

Presently, several FOG technologies including open and closed schemes are available for the measurement of the Sagnac effect. Most of them adopt a two-by-two (2×2) directional coupler (also called optical splitter) to construct the interferometer. By using a sensing coil, a rotational movement is picked up and analyzed. Due to the nature of its architecture, the detected waveform signal is sinusoidal yet in a cosine term. Despite that the direct cosine output from the conventional FOGs is more sensitive at its high speed rotation, there still exist a need for a high sensitivity at small rotation speeds. Feasible solutions to this problem include the use of a more complex digital signal processing or the incorporation of a phase modulator, which may satisfy the requirement. One drawback to these solutions, however, is that sophisticated electronics and extra optical components are required for the construction, which would not only considerably increase the manufacturing cost but also raise a concern in reliability.

One solution to the drawback of using a 2×2 type of directional coupler for FOG construction is to replace it with a 3×3 type. Presently, various patents have been disclosed that use a 3×3 type of directional coupler in the FOG architecture. The following is a list of these patents:

U.S. Pat. No. 4,440,498 entitled “OPTICAL FIBER GYROSCOPE WITH (3×3) DIRECTIONAL COUPLER”.
U.S. Pat. No. 4,479,715 entitled “OPTICAL ROTATION-SENSING INTERFEROMETER WITH (3×3)-(2×2) DIRECTIONAL COUPLER”.
U.S. Pat. No. 4,653,917 entitled “FIBER OPTIC GYROSCOPE OPERATING WITH UNPOLARIZED LIGHT SOURCE”.
U.S. Pat. No. 4,944,590 entitled “OPTICAL-FIBER GYROSCOPE OF SAGNAC TYPE HAVING A FIBER-OPTIC LOOP AND 3×3 COUPLER”.
U.S. Pat. No. 5,777,737 entitled “APPARATUS AND METHOD FOR PROCESSING SIGNALS OUTPUT FROM FIBER OPTIC RATE GYROSCOPE HAVING 3×3 COUPLER”.
WO 97/21981 entitled “OPTIMUM CONFIGURATION OF A 3×3 COUPLER FORA FIBER OPTIC GYROSCOPE”.

According to a paper published in the Journal of Optics Letters by S. Merlo, M. Norgia and S. Donati, the output of an FOG constructed on a 3×3-type of directional coupler can be expressed by the following equation:

$$I 1 - I 2 = \frac{2 \sqrt{3}}{9} σ P sin ( 2 {φ}_{s} )$$

where
I1 and I2 are the output photodiode currents with respect to FOG output pigtails;
σ is the responsivity of the photodiodes;
P is the light source power; and
φₛ is the Sagnac phase response.

The above equation demonstrates that the use of a 3×3-type of directional coupler allows the FOG to have an inherent response that is twice larger than the 2×2-type, given that the coil size is the same. In addition, the use of a 3×3-type directional coupler has several other advantages. One is the capability of direct discrimination on the direction of rotation due to a sine instead of cosine phase angle term, and the other is its intrinsically maximum sensitivity at extremely small rotation near zero angular rate. In the latter case, the gyro sensitivity at any rotation speed can be calculated by taking derivative of the above equation, which shows an outcome factor approaching infinity as the FOG's rotation speed approaches zero.

One drawback to the conventional FOGs constructed on a 3×3-type of directional coupler, however, is that they lack the capability to allow the two split beams that travel in opposite directions through the coiled optical fiber to maintain their linear polarization all the way through the optical propagation path. This drawback would undesirably cause common mode phase noises due to polarization crosstalk between the two split beams that undesirably cause perturbations and drifts to the phases of the two split beams while they are traveling in opposite directions against each other through the coiled optical fiber. The occurrence of the common mode phase noises caused by polarization crosstalk is not only stochastic in nature but would be strongly affected by any variations in the environmental temperature and external stresses and vibrations. This issue had been pointed out and elaborated, for example, by G. Trommer in the technical publication entitled “Optical Gyros and their Applications”, Chapter 8: “Passive All-fiber Open Loop Gyroscope”, RTO AGARDograph 339, 199.

Therefore, in view of the above-mentioned problem of common mode phase noises caused by polarization crosstalk in the conventional FOGs, there exists a need in the industry for a solution to this problem that can help eliminate and reduce the common mode phase noises and thereby enhance the sensitivity and accuracy in the observation and measurement of the Sagnac effect for precise detection of a rotational movement.

### SUMMARY OF THE INVENTION

It is therefore the primary objective of the invention to provide an improved FOG which represents a solution to the above-mentioned problem of common mode phase noises caused by polarization crosstalk in the conventional FOGs for the purpose of enhancing the sensitivity and accuracy in the observation and measurement of the Sagnac effect for precise detection of the angular speed of a rotational movement.

In accordance with invention, the improved FOG is constructed specifically and characteristically in compliance with a combination of the following four engineering guides to solve the above-mentioned problem:
(1) the arrangement of a symmetric beam-splitting configuration for the 3×3 directional coupler so as to allow the two opposing beams travelling through the coiled optical fiber to be substantially equal in their phase amplitudes;
(2) the arrangement of a polarization-maintaining mechanism for maintaining linear beam polarization substantially all the way through the beam propagation path;
(3) the arrangement of a single common optical path in the coiled optical fiber for the two opposing beams to travel therethrough; and
(4) the arrangement of a pair of photo detectors for the detection of a pair of differential phase signals that indicate the angular speed of a rotational movement.

The combined use of the above approaches in cooperation can help significantly eliminate and reduce the common mode phase noises that would be otherwise caused by polarization crosstalk to a minimum possible level that has never been achieved by the conventional FOGs, thus enhancing the measurement sensitivity and accuracy to a much higher level for more precise detection of the angular speed of a rotational movement.

By experiment, it can be evidently proved and demonstrated that the invention allows the common mode phase noise in the detected differential phase signals to be eliminated and reduced to a much lower level that is many folds better than the conventional FOGs by means of the combined use of a phase modulator, a two-by-two fiber coupler, more sophisticated optics, and electronics, typically as low as approximately 1 μrad/\sqrt{Hz} as compared to nearly 10 μrad/\sqrt{Hz} or even higher in the conventional FOGs. As a result, the sensitivity and accuracy in the observation and measurement of the Sagnac effect can be significantly enhanced for precise detection of the angular speed of a rotational movement.

### BRIEF DESCRIPTION OF THE DRAWINGS

The invention can be more fully understood by reading the following detailed description of the preferred embodiments, with reference made to the accompanying drawings, wherein:

FIG. 1 is a schematic diagram showing the architecture of an improved FOG designed in accordance with the invention;

FIG. 2 is a schematic diagram showing the linking of the improved FOG of the invention to a signal processing unit;

FIG. 3 is a schematic diagram showing an example of the implementation of the linearly-polarized light source utilized by the improved FOG of the invention;

FIG. 4 is a schematic diagram showing the conceptual topology of a symmetric beam-splitting configuration for the polarization-maintaining 3×3 directional coupler utilized by improved FOG of the invention;

FIG. 5A is a schematic diagram showing a first embodiment of the symmetric beam-splitting configuration shown in FIG. 4;

FIG. 5B is a schematic diagram showing a second embodiment of the symmetric beam-splitting configuration shown in FIG. 4;

FIG. 6 is a graph showing a measured plot of phase drift versus time characteristic of the detected differential phase signals by the improved FOG of the invention;

FIGS. 7A-7C are graphs used to show the phase noise characteristic of the improved FOG of the invention; and

FIGS. 8A-8B are graphs used to show the phase noise characteristic of a conventional FOG that lacks the adoption of a symmetric PM beam-splitting configuration for the 3×3 directional coupler.

### DETAILED DESCRIPTION OF THE PREFERRED EMBODIMENT

The present invention proposes an improved-type of fiber-optic gyroscope (FOG) which represents a solution to the problem of common mode phase noises that would be otherwise caused by polarization crosstalk in the conventional FOGs for the purpose of enhancing the sensitivity and accuracy in the observation and measurement of the Sagnac effect for more precise detection of the angular speed of a rotational movement. The improved FOG of the invention is disclosed in full details by way of preferred embodiments in the following with reference to the accompanying drawings.

### Architecture of the Improved FOG

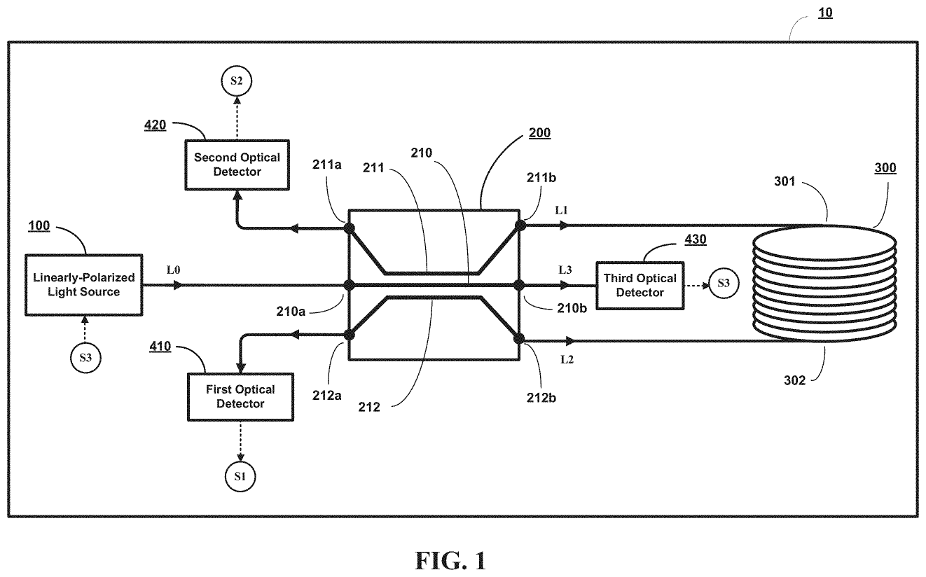

FIG. 1 is a schematic diagram showing the architecture of the improved FOG designed in accordance with the invention, which is the part enclosed in the box indicated by the reference numeral 10. Like conventional FOGs, the improved FOG 10 of the invention is also based on the principle of the Sagnac effect for detection of the angular speed of a rotational movement, such as the motion of the earth, or a change in the direction of a vehicle, such as a car, a ship, or an airplane. Unlike the conventional FOGs, however, the improved FOG 10 is distinctively characterized by the capability to drastically eliminate and reduce the common mode phase noises that would be otherwise caused by polarization crosstalk in the conventional FOGs and thus undesirably degrade the sensitivity and accuracy in the observation and measurement of the Sagnac effect. By experiment, it can be evidently proved and demonstrated that the invention allows the common mode phase noises in the output differential phase signals (S1, S2) to be eliminated and reduced to a much lower level that is many folds better than the conventional FOGs, typically as low as approximately 1 μrad/\sqrt{Hz} compared to nearly 10 μrad/\sqrt{Hz} or even higher in the conventional FOGs. As a result, the invention allows the sensitivity and accuracy of the measured results to be considerably enhanced to a much higher level that has never been achieved by the conventional FOGs. Details about the construction and features of the improved FOG 10 will be described in the following.

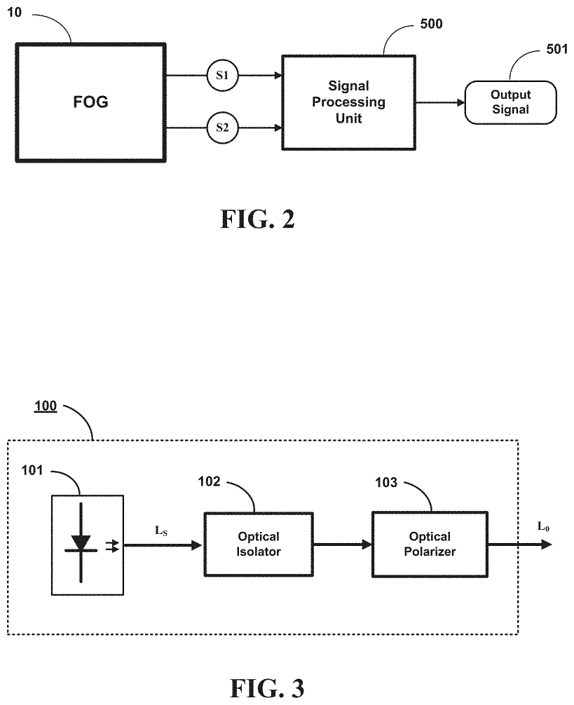

As shown in FIG. 1, in construction, the improved FOG 10 comprises the following constituent elements: (a) a linearly-polarized light source 100; (b) a polarization-maintaining three-by-three directional coupler 200 (hereinafter referred in short as “PM 3×3 directional coupler”); (c) a coiled polarization-maintaining optical fiber 300 (hereinafter referred in short as “coiled PM optical fiber”); and (d) a pair of photo detectors including a first photo detector 410 and a second photo detector 420. Furthermore, the improved FOG 10 can optionally include a third photo detector 430. In application, as shown in FIG. 2, the improved FOG 10 is further linked to a signal processing unit 500, which can be either an internally-integrated part of the improved FOG 10 or an externally-connected module, and which is used to process the output differential phase signals (S1, S2) to determine the angular speed of a rotational movement.

The above-listed constituent elements of the improved FOG 10 designed in accordance with the invention will be respectively described in detail with regard to their structures, functions, and interconnections in the following.

### Linearly-Polarized Light Source 100

The linearly-polarized light source 100 is used for supplying a linearly-polarized light beam which is substantially linearly polarized and fixed in phase amplitude for use as an interrogating beam L0 for the observation and measurement of the Sagnac effect. Preferably, the linearly-polarized light source 100 is a low-coherence source. The interrogating beam L0 emitted from the linearly-polarized light source 100 is subsequently transmitted to the PM 3×3 directional coupler 200.

In practice, as for example shown in FIG. 3, the linearly-polarized light source 100 can be implemented with a module that is composed of a light-emitting diode (LED) 101, an optical isolator 102, and an optical polarizer 103.

The LED 101 is capable of emitting a light beam Ls which is then transmitted via the optical isolator 102 to the optical polarizer 103 where the light beam Ls is linearly polarized to produce a linearly-polarized light beam that serves as the interrogating beam L0. In practice, for example, the LED 101 has an output power in the range of 100-200 μW (micro-watt) with a spectrum centered at 1550 nm (nanometer), an FWHM (full width at half maximum) larger than 40 nm, and a PER (polarization extinction ratio) larger than 17 dB. In manufacture, the LED 101 can be encapsulated, for example, in a DIL (dual in-line) package with a built-in Peltier cooler. Moreover, the LED 101 can operate in an automatic power control mode based on a feedback waveform signal S3 from the third photo detector 430 for the purpose of allowing its output power to be substantially regulated constantly at a prespecified fixed level within an error of less than 0.5%.

The optical isolator 102 has a first port 121 and a second port 122 for providing a one-way optical transmission path from the first port 121 to the second port 122, i.e., it allows light propagation only from the first port 121 to the second port 122, and not reversely from the second port 122 to the first port 121. The optical isolator 102 is coupled between the LED 101 and the optical polarizer 103 such that it only allows the light beam Ls from the LED 101 to pass therethrough to the optical polarizer 103 while prohibiting any returned beams from the PM 3×3 directional coupler 200 to pass therethrough to the LED 101.

The optical polarizer 103 is used to polarize the light beam Lₛ emitted from the LED 101 into a linearly-polarized mode such that the interrogating beam L0 is linearly polarized. The optical polarizer 103 has a high PER (polarization extinction ratio), for example 20 db.

### PM 3×3 Directional Coupler 200

The PM 3×3 directional coupler 200 (also called a 3×3 optical splitter) is composed of three optical waveguides, including a main waveguide 210, a first branching waveguide 211, and a second branching waveguide 212, for splitting the interrogating beam L0 emitted from the linearly-polarized light source 100 into three beams: a first beam L1, a second beam L2, and a third beam L3.

The main waveguide 210 has a first port 210a and a second port 210b. In configuration, the first port 210a is connected to receive the interrogating beam L0 emitted from the linearly-polarized light source 100, while the second port 210b is connected to the third photo detector 430 so as to transmit the third beam L3 to the third photo detector 430.

The first branching waveguide 211 has a first port 211a and a second port 211b. The first port 211a is connected to the second photo detector 420 so that after the second beam L2 exits the coiled PM optical fiber 300, it will be transmitted to the second photo detector 420. On the other hand, the second port 211b is connected to a first end 301 of the coiled PM optical fiber 300 so as to transmit the first beam L1 to the coiled PM optical fiber 300.

The second branching waveguide 212 has a first port 212a and a second port 212b. The first port 212a is connected to the first photo detector 410 so that after the first beam L1 exits the coiled PM optical fiber 300, it will be transmitted to the first photo detector 410. On the other hand, the second port 212b is connected to a second end 302 of the coiled PM optical fiber 300 so as to transmit the second beam L2 to the coiled PM optical fiber 300.

In accordance with one important aspect of the invention, the PM 3×3 directional coupler 200 used here has a polarization-maintaining (PM) capability that allows the three split beams (L1, L2, L3) to maintain their linear polarization with respect to the incoming interrogating beam L0 which is originally linearly polarized. The PM 3×3 directional coupler 200 has a high PER (polarization extinction ratio), for example larger than 15 dB.

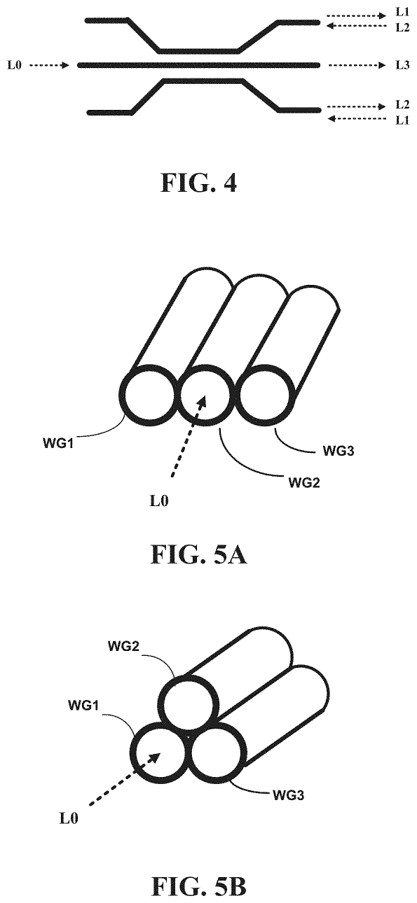

In accordance with another important aspect of the invention, the PM 3×3 directional coupler 200 used here is strictly arranged in a symmetric beam-splitting configuration which is conceptually shown in the topology of FIG. 4. The symmetric beam-splitting configuration means that the splitting of the interrogating beam L0 into the two beams (L1, L2) is carried out in a strictly symmetric manner in order to thereby provide an equally-balanced power splitting ratio for the two split beams (L1, L2) so that they would each carry substantially the same power, thus substantially equal in their phase amplitudes. This configuration can help prevent phase perturbations and drifts due to a difference in phase amplitude between the two split beams (L1, L2) while they are travelling through the coiled PM optical fiber 300. In practice, for example, the symmetric beam-splitting configuration can be arranged in such a manner that the interrogating beam L0 is equally divided so that the three split beams (L1, L2, L3) each carry one-third of the original power of the interrogating beam L0, or that the three split beams (L1, L2, L3) carry respectively 40%, 40%, and 20% of the original power of the interrogating beam L0. Fundamentally, the symmetric beam-splitting configuration should be implemented in such a manner that allows the two split beams (L1, L2) to be equal in their phase amplitudes.

In practice, for example, there are two different alternative ways to implement the above-described symmetric beam-splitting configuration, as respectively shown in FIG. 5A and FIG. 5B.

In the example of FIG. 5A, the PM 3×3 directional coupler 200 used here is constructed by bundling three waveguides WG1, WG2, WG3 in a linearly-juxtaposed formation in cross-sectional view, in which the waveguide WG2 is positioned in the center-most position with respect to the other two waveguides WG1, WG3. In this case, the center-most waveguide WG2 is chosen to serve as the main waveguide 210, while the other two adjacent waveguides WG1, WG3 are chosen to serve respectively as the first and second branching waveguides 211, 212. By this configuration, after the interrogating beam L0 enters the center-most waveguide WG2, it will be split into three beams (L1, L2, L3), with the two beams (L1, L2) being symmetrically split such that the two beams (L1, L2) are substantially equal in their phase amplitudes. The two split beams (L1, L2) then propagate respectively through the two adjacent waveguides WG1, WG3, while the third beam L3 still remains to propagate through the center-most waveguide WG2.

In the example of FIG. 5B, the PM 3×3 directional coupler 200 used here is constructed by bundling three waveguides WG1, WG2, WG3 in a triangular formation in cross-sectional view. In this case, any arbitrary one of the three waveguide WG1, WG2, WG3 can be chosen to serve as the main waveguide 210, with the other two waveguides serving respectively as the first and second branching waveguides 211, 212. For example, if the waveguide WG1 is chosen to serve as the main waveguide 210, then the other two waveguides WG2, WG3 are used to serve respectively as the first and second branching waveguides 211, 212; and if the waveguide WG2 is chosen to serve as the main waveguide 210, then the other two waveguides WG1, WG3 are used to serve respectively as the first and second branching waveguides 211, 212. In the case of FIG. 5B, it is assumed that the waveguide WG1 is chosen as the main waveguide 210, while the other two waveguides WG2, WG3 are chosen to serve respectively as the first and second branching waveguides 211, 212. By this configuration, when the interrogating beam L0 enters the waveguide WG1, it will be split into three beams (L1, L2, L3), with the two beams (L1, L2) being symmetrically split such that the two beams (L1, L2) are substantially equal in their phase amplitudes. The two beams (L1, L2) then propagate respectively through the two adjacent waveguides WG2, WG3, while the third beam L3 still remains to propagate through the waveguide WG1.

By the above-described symmetric beam-splitting configuration for the PM 3×3 directional coupler 200, as exemplarily shown in FIG. 5A and FIG. 5B, it allows the two beams (L1, L2) to be split in a symmetrically manner with an equally-balanced power splitting ratio for each such that the two split beams (L1, L2) are substantially equal in their phase amplitudes. As a result, when the two beams (L1, L2) are travelling in opposite directions through the coiled PM optical fiber 300, they can be prevented from phase perturbations and drifts due to a difference in phase amplitude between the two opposing beams (L1 L2), thereby reducing the common mode phase noises in the two beams (L1 L2).

### Coiled PM Optical Fiber 300

The coiled PM optical fiber 300 is wound in a circularly coiled shape such that it can be used to implement the observation and measurement of the Sagnac effect. The coiled PM optical fiber 300 provides one single common optical path having two opposite open ends: a first end 301 and a second end 302. The first end 301 is optically coupled to receive the first beam L1 from the second port 211b of the first branching waveguide 211 in the PM 3×3 directional coupler 200, while the second end 302 is optically coupled to receive the second beam L2 from the second port 212b of the second branching waveguide 212 in the PM 3×3 directional coupler 200. This allows the first beam L1 and the second beam L2 to travel in opposite directions, one in clockwise direction and the other in counterclockwise direction, through the one single common optical path provided by the coiled PM optical fiber 300. After travelling through the coiled PM optical fiber 300, the first beam L1 will exit the coiled PM optical fiber 300 from the second end 302 and then propagate to the second port 212b of the second branching waveguide 212 in the PM 3×3 directional coupler 200 such that it will be further transmitted via the second branching waveguide 212 to the first photo detector 410. On the other hand, the second beam L2 will exit from the first end 301 and then propagate to the second port 211b of the first branching waveguide 211 in the PM 3×3 directional coupler 200 such that it will be further transmitted via the first branching waveguide 211 of the PM 3×3 directional coupler 200 to the second photo detector 420.

In practice, the coiled PM optical fiber 300 has a predefined suitable length, typically in the range from 100 meters to 5000 meters or longer, and a predefined suitable diameter, for example 55 mm (millimeter). Moreover, the coiled PM optical fiber 300 has a high PER (polarization extinction ratio), for example 25 dB, and a low insertion loss (IL), for example below 0.1 dB. In configuration, the PM optical fiber 300 is preferably wound with a quadruple scheme for preventing the phase drifting effect that would be otherwise caused by an ambient thermal gradient.

In realization, the coiled PM optical fiber 300 can be implemented by using any optical fibers with PM capability. Presently, there are various types of PM-capable fibers, such as a stress-rod type, an elliptical-cladding type, and a bow-tie type. The stress-rod type of PM optical fiber is also called “PANDA”, which is so named due to the resemblance of the fiber's cross-section to a panda's face, and is also used as an acronym for “Polarization-maintaining AND Absorption-reducing”. In addition to the herein mentioned three types, other types of PM-capable fibers can also be used to implement the coiled PM optical fiber 300.

It is an important aspect of the invention that the coiled PM optical fiber 300 in combination with the linearly-polarized light source 100 and the PM 3×3 directional coupler 200 constitute a polarization-maintaining (PM) mechanism that allows the interrogating beam L0 as well as the two split beams (L1, L2) to substantially maintain their linear polarization all the way through the propagation path. As a result, the PM mechanism can help prevent the undesired effect of polarization crosstalk between the two beams (L1, L2) that would otherwise occur in conventional FOGs that lack the PM capability, thus eliminating and reducing the common mode phase noises in the two beams (L1 L2). In practice, this PM mechanism can be exploited to provide the maximum possible level of PM capability if the overall optical propagation path composed of the linearly-polarized light source 100, the PM 3×3 directional coupler 200, and the coiled PM optical fiber 300. By experiment, it can be evidently proved and demonstrated that the configuration of the PM mechanism arranged in compliance with the four engineering guidelines (1)-(4) specified in the SUMMARY OF THE INVENTION section of this specification can provide an optimized PM capability that can eliminate and reduce the common mode phase noises to a minimum possible level that has never been achieved by the conventional FOGs.

It is another important aspect of the invention that the one single common optical path provided by the coiled PM optical fiber 300 for the two opposing beams (L1, L2) travelling in opposite directions therethrough allows the two opposing beams (L1 L2) to travel exactly the same distance through the coiled PM optical fiber 300. This can help maintain the phase coherence between the two opposing beams (L1, L2), thus preventing deviations in the phase coherence that would otherwise cause the occurrence of common mode phase noises.

After exiting the PM optical fiber 300, the first beam L1 subsequently propagates via the second branching waveguide 212 of the PM 3×3 directional coupler 200 to the first photo detector 410, while the second beam L2 subsequently propagates via the first branching waveguide 211 of the PM 3×3 directional coupler 200 to the second photo detector 420.

### Photo Detectors (410, 420, 430)

The paired first and second photo detectors 410, 420 are respectively connected to receive and optically sense the first beam L1 and the second beam L2 after they exit the coiled PM optical fiber 300 to thereby generate a pair of differential phase signals (S1, S2). The first photo detector 410 is used to generate a first waveform signal in analog electrical form in response to the received light intensity, which is predominantly the first beam L1 but may contain a small negligible portion of the second beam L2 that is strayed from the first branching waveguide 211 to the second branching waveguide 212; while the second photo detector 420 is used to generate a second waveform signal in analog electrical form in response to the received light intensity, which is predominantly the second beam L2 but may contain a small negligible portion of the first beam L1 that is strayed from the second branching waveguide 212 to the first branching waveguide 211. The two waveform signals are then outputted as a pair of differential phase signals (S1, S2). Based on the principle of the Sagnac effect, when there is a rotational movement, it will cause the occurrence of a phase difference ΔS between the two differential phase signals (S1, S2). Accordingly, the paired differential phase signals (S1, S2) serve as an indication of the angular speed of the rotational movement. Therefore, the paired differential phase signals (S1, S2) can be further processed to determine the angular speed of the rotational movement. In practice, both the first photo detector 410 and the second photo detector 420 can be implemented by using any type of photo detector that can convert light into an electrical signal, such as an InGaAs-type of photo detector.

The third photo detector 430 is an optional component, which is connected to receive and optically sense the third beam L3 outputted from the second port 210b of the main waveguide 210 in the PM 3×3 directional coupler 200 to thereby generate a third waveform signal S3 in analog electrical form that indicates the power level (i.e., phase amplitude) of the third beam L3. The third waveform signal S3 is then used as a feedback signal to the linearly-polarized light source 100 for automatic feedback power control to allow the output power of the linearly-polarized light source 100 to be normalized at a prespecified fixed power level within an error range of less than 0.5% such that the interrogating beam L0 can be stably maintained at a fixed phase amplitude all the time during the operation. In practice, the third photo detector 430 can be implemented with any type of photo detector that can convert light into an electrical signal, such as an InGaAs-type of photo detector.

### Signal Processing Unit 500

The signal processing unit 500 can be either an internally-integrated part of the improved FOG 10 or an externally-linked module. The signal processing unit 500 is connected to receive the paired differential phase signals (S1, S2) respectively from the first photo detector 410 and the second photo detector 420. When there is no rotational movement, the two differential phase signals (S1, S2) will be synchronized in phase. However, when there is a rotational movement, it will induce the so-called Sagnac effect which causes a differential phase shift ΔS between S1 and S2, where ΔS is correlated with the angular speed the rotational movement. Accordingly, the signal processing unit 500 is configured to process the differential phase signals (S1, S2) based on the principle of the Sagnac effect to first detect the differential phase shift ΔS between S1 and S2, and then use ΔS to calculate the angular speed of the rotational movement. Since the operation of the signal processing unit 500 for determining the angular speed of the rotational movement is based on the well-known principle of the Sagnac effect and the same as conventional FOGs, detailed description thereof will not be given in this specification. The signal processing unit 500 finally generates an output signal 501, which can be either in analog form or digital form, for indicating the angular speed of the rotational movement. In practice, for example, the signal processing unit 500 can be implemented with a desktop or notebook PC which includes a USB port for receiving the two differential phase signals (S1, S2), and a 4-channel 12-bit analog-to-digital (A/D) converting circuit for converting (S1, S2) into digital form such that (S1, S2) can be digitally processed to calculate the angular speed of the rotational movement. Beside this, the signal processing unit 500 can also be implemented with a dedicated custom-made IC (integrated circuit) chip for use as an internally-integrated part of the improved FOG 10

### Operation of the Improved FOG

In operation, the improved FOG 10 operates in a similar manner as the conventional FOGs as follows. When switched on, the linearly-polarized light source 100 emits a linearly-polarized interrogating beam L0 which is then split by the PM 3×3 directional coupler 200 into three beams: a first beam L1, a second beam L2, and a third beam L3. Subsequently, the first beam L1 is injected into the first end 301 while the second beam L2 is injected into the second end 302 of the coiled PM optical fiber 300, such that the two beams (L1, L2) will travel in opposite directions against each other, one in clockwise direction while the other in counterclockwise direction, through the coiled PM optical fiber 300 for use in the observation and measurement of the Sagnac effect. When the improved FOG 10 is undergoing a rotational movement, it will cause one of the two opposing beams (L1, L2) in the coiled PM optical fiber 300 that propagates in opposite direction against the rotational movement to experience a slightly shorter delay than the other, thus resulting in a differential phase shift ΔS between the two opposing beams (L1, L2).

After existing the coiled PM optical fiber 300, the first beam L1 is subsequently transmitted via the second branching waveguide 212 of the PM 3×3 directional coupler 200 to the first photo detector 410, while the second beam L2 is transmitted via the first branching waveguide 211 of the PM 3×3 directional coupler 200 to the second photo detector 420. In response, the first photo detector 410 and the second photo detector 420 will generate a pair of differential phase signals (S1, S2) in analog electrical form, where S1 indicates the waveform of the first beam L1, while S2 indicates the waveform of the second beam L2. The paired differential phase signals (S1, S2) are then transferred to the signal processing unit 500, where they are processed to detect the differential phase shift ΔS between S1 and S2, and then use ΔS to calculate the angular speed of the rotational movement based on the principle of the Sagnac effect. The signal processing unit 500 finally generates an output signal 501 which indicates the angular speed of the rotational movement.

### Characterizing Features of the Improved FOG

Compared to the conventional FOGs that are constructed on a 3×3 directional coupler, the improved FOG 10 is distinctively characterized by a combined use of several approaches that work in cooperation to solve the problem of common mode phase noises in the conventional FOGs so that the improved FOG 10 is able to significantly enhance the measurement sensitivity and accuracy as compared to the conventional FOGs. These approaches include the following:
(1) a strict symmetric beam-splitting configuration for the PM 3×3 directional coupler 200, which allows the two opposing beams (L1, L2) travelling through the coiled PM optical fiber 300 to be substantially equally balanced in power such that their phase amplitudes are substantially equal. This can help prevent phase perturbations and drifts that could be otherwise caused by a difference in phase amplitude between the two opposing beams (L1 L2), thus reducing the common mode phase noises.
(2) a polarization-maintaining mechanism substantially all the way through the optical propagation path, which is composed of the linearly-polarized light source 100, the PM 3×3 directional coupler 200, and the coiled PM optical fiber 300. This PM mechanism can effectively prevent the undesired effect of polarization crosstalk between the two opposing beams (L1, L2) substantially all the way through the optical propagation path. As a result, the two opposing beams (L1, L2) would have a low random walk in phase, which can further help eliminate and reduce the common mode phase noises to a lower level.
(3) the arrangement of one single common optical path provided by the coiled PM optical fiber 300 for the two opposing beams (L1, L2) so as to allow the two opposing beams (L1 L2) to travel exactly the same distance through the one single common optical path provided by the coiled PM optical fiber 300. This arrangement can help maintain the phase coherence between the two opposing beams (L1, L2), thus preventing deviations in the phase coherence that would otherwise cause the occurrence of common mode phase noises.
(4) the configuration of a pair of photo detectors 410, 420, instead of just one as in some conventional FOGs, for the optical sensing of the paired differential phase signals (S1, S2). This configuration can also help cancel common mode phase noises in the detected differential phase signals (S1, S2) and double the optical sensing response.

The combined use of the above approaches allows an effective elimination and reduction of the common mode phase noises in the detected differential phase signals (S1, S2) to a minimum possible level that has never been achieved by the conventional FOGs, thus significantly enhancing the measurement sensitivity and accuracy to a much higher level for more precise detection of the angular speed of a rotational movement.

### Phase Noise Reduction Performance of the Improved FOG

By experiment, it can be evidently proved and demonstrated that the invention allows the level of common mode phase noises to be reduced to a much lower level that is many folds better than the conventional FOGs. Due to this substantial reduction in the common mode phase noises, the improved FOG 10 is able to enhance the measurement sensitivity and accuracy to a significantly much higher level for more precise detection of the angular speed of a rotational movement that has never achieved by the conventional FOGs.

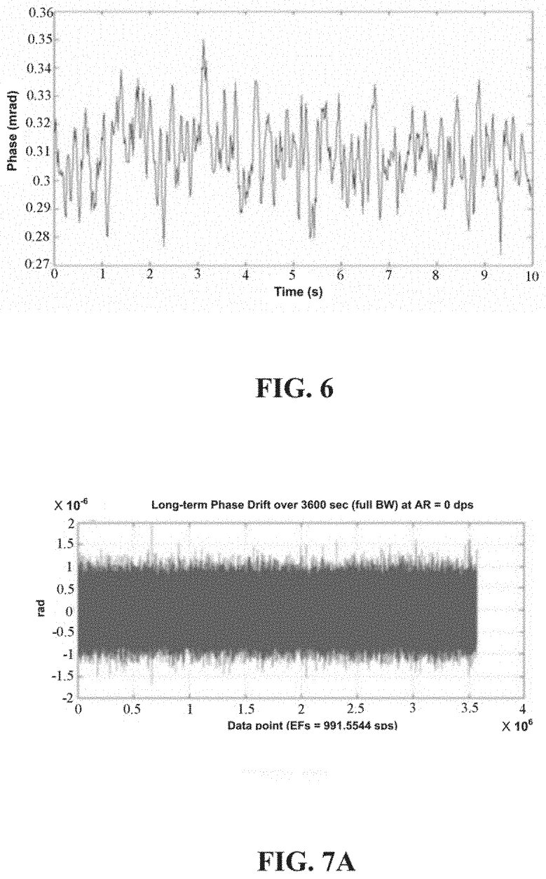

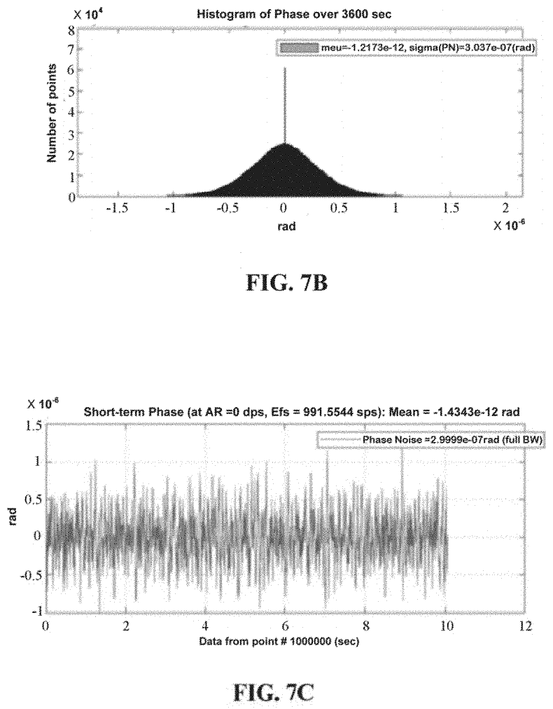

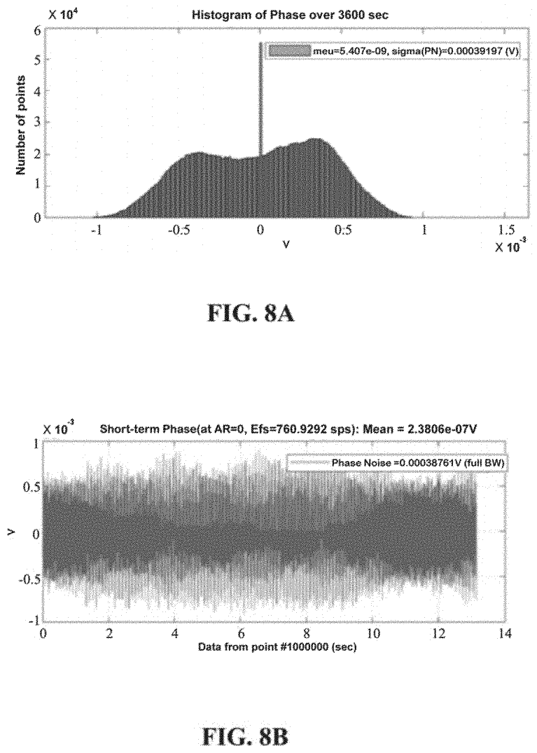

The experimentally measured phase noise characteristics of the improved FOG 10 designed in accordance with the invention in comparison with the conventional FOGs are shown in FIG. 6, FIGS. 7A-7C, and FIGS. 8A-8B.

FIG. 6 is a graph showing a measured plot of the phase noise characteristics of the differential phase signals (S1, S2) generated by the improved FOG 10. As shown, it can be seen that the phase noise level fluctuates within a significantly smaller range than the conventional FOGs.

FIGS. 7A-7C and FIGS. 8A-8B are two sets of graphs for use as a comparison to demonstrate how the improved FOG 10 according to the invention is more superior and advantageous in the capability and performance of eliminating and reducing the common mode phase noises than the conventional FOGs.

FIGS. 7A-7C are graphs showing the measured phase noise characteristics of the improved FOG 10. FIG. 7A shows a characteristic plot of the long-term phase drift over a period of 3600 seconds, which represents a typical phase noise profile from a zero angular rate data sampled at 991.55 samples/sec with bias removed; FIG. 7B is a histogram showing the distribution of the phase noise profile of FIG. 7A; and FIG. 7C shows an arbitrarily selected 10-sec zoom-in portion of the phase noise profile shown in FIG. 7A. From the graph of FIG. 7A, it can be clearly seen that the invention allows the long-term phase drift to be reduced to as low as approximately 1 μrad/\sqrt{Hz}. As a comparison, the phase drift in the conventional FOGs would be typically nearly 10 μrad/\sqrt{Hz} or even much higher. Therefore, it can be evidently proved and demonstrated that the improved FOG 10 designed in accordance with the invention allows the phase error to be significantly reduced to a much lower level that is many folds better than the conventional FOGs.

As a comparison, FIGS. 8A-8B are graphs showing the measured phase noise characteristics of a conventional FOG that lacks the adoption of a symmetric beam-splitting configuration for the 3×3 directional coupler. It can be seen from the histogram of FIG. 8A that there is a rather broader and non-monotonically decreasing distribution statistics away from its center average as compared to FIG. 7B. In addition, it can be seen from FIG. 8B that there is an undesired beating effect in the time domain of the detected waveform signals. Both of these two undesired effects can be ascribed to be caused by an increased level of polarization crosstalk resulted from the lack of a symmetric beam-splitting configuration for the 3×3 directional coupler. By comparing FIGS. 7A-7C with FIGS. 8A-8B, it can be evidently shown that, with the adoption of a symmetric beam-splitting configuration for the PM 3×3 directional coupler 200, the improved FOG 10 is able to significantly eliminate and reduce the common mode phase noises in the detected differential phase signals (S1, S2) to a very low level, thus considerably enhancing the measurement sensitivity and accuracy of the differential phase signals (S1, S2) as compared to the conventional FOGs.

By experiment, it can be evidently shown that the improved FOG 10 allows the overall level of common mode phase noises in the detected differential phase signals (S1, S2) to be eliminated and reduced to a much lower level that is many folds better than the conventional FOGs, typically as low as approximately 1 μrad/\sqrt{Hz} as compared to nearly 10 μrad/\sqrt{Hz} or even higher in the conventional FOGs. Therefore, it can be concluded that the improved FOG 10 is more superior and advantageous in the capability and performance of eliminating and reducing the common mode phase noises to a minimum possible level that has never been achieved by the conventional FOGs, thus significantly enhancing the measurement sensitivity and accuracy as compared to conventional FOGs.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A fiber-optic gyroscope, comprising:
(a) a linearly-polarized light source for generating a linearly-polarized light beam to serve as an interrogating beam;
(b) a polarization-maintaining 3×3 directional coupler having three waveguides including a main waveguide, a first branching waveguide, and a second branching waveguide, for splitting the interrogating beam into a first beam, a second beam, and a third beam; wherein the main waveguide is optically coupled to receive the interrogating beam from the linearly-polarized light source while the first branching waveguide and the second branching waveguide are respectively used to transmit the first beam and the second beam; and wherein the main waveguide, the first branching waveguide, and the second branching waveguide are arranged in a symmetric beam-splitting configuration in order to split the interrogating beam in a symmetric manner into the first beam and the second beam with an equally-balanced power splitting ratio such that the first beam and the second beam are substantially equal in phase amplitude;
(c) a coiled polarization-maintaining optical fiber, which provides one single common optical path having two opposite ends respectively optically coupled to receive the first beam and the second beam from the polarization-maintaining 3×3 directional coupler, thereby allowing the first beam and the second beam to travel in opposite directions through the one single common optical path provided by the coiled polarization-maintaining optical fiber for observation and measurement of the Sagnac effect; and
(d) a pair of photo detectors including a first photo detector and a second photo detector, which are optically coupled via the polarization-maintaining 3×3 directional coupler to respectively receive and optically sense the first beam and the second beam after exiting from the coiled polarization-maintaining optical fiber to thereby generate a pair of differential phase signals that indicate, in the event of a rotational movement, the angular speed of the rotational movement; wherein
the linearly-polarized light source, the polarization-maintaining 3×3 directional coupler, and the coiled polarization-maintaining optical fiber in combination constitute a polarization-maintaining mechanism that allows the interrogating beam as well as the first beam and the second beam to maintain linear polarization substantially all the way through the optical propagation path starting at the linearly-polarized light source and ending at the first photo detector and the second photo detector, thereby preventing polarization crosstalk between the first beam and the second beam for the purpose of eliminating and reducing common mode phase noises in the detected differential phase signals.

2. The fiber-optic gyroscope of claim 1, wherein in the case that the three waveguides of the polarization-maintaining 3×3 directional coupler are bundled in a linearly-juxtaposed formation, the symmetric beam-splitting configuration is implemented in such a manner that the center-most one of the three waveguides is chosen to serve as the main waveguide.

3. The fiber-optic gyroscope of claim 1, wherein in the case that the three waveguides of the polarization-maintaining 3×3 directional coupler are bundled in a triangular formation, the symmetric beam-splitting configuration is implemented in such a manner that an arbitrary one of the three waveguides is chosen to serve as the main waveguide.

4. The fiber-optic gyroscope of claim 1, wherein the coiled polarization-maintaining optical fiber is a stress-rod type, an elliptical-cladding type, or a bow-tie type.

5. The fiber-optic gyroscope of claim 1, further comprising:
a third photo detector, connected to receive and optically sense the third beam from the polarization-maintaining 3×3 directional coupler, for generating a signal that indicates the power level of the third beam for automatic feedback control of the linearly-polarized light source in order to maintain the interrogating beam at a substantially fixed phase amplitude.

6. The fiber-optic gyroscope of claim 1, further comprising:
a signal processing unit, connected to receive the pair of differential phase signals from the first photo detector and the second photo detector, for processing the pair of differential phase signals based on the principle of the Sagnac effect to thereby generate an output signal that indicates the angular velocity of the rotational movement.

7. A fiber-optic gyroscope, comprising:
(a) a linearly-polarized light source for generating a linearly-polarized light beam to serve as an interrogating beam;
(b) a polarization-maintaining 3×3 directional coupler having three waveguides including a main waveguide, a first branching waveguide, and a second branching waveguide, for splitting the interrogating beam into a first beam, a second beam, and a third beam; wherein the main waveguide is optically coupled to receive the interrogating beam from the linearly-polarized light source while the first branching waveguide and the second branching waveguide are respectively used to transmit the first beam and the second beam; and wherein the main waveguide, the first branching waveguide, and the second branching waveguide are arranged in a symmetric beam-splitting configuration in order to split the interrogating beam in a symmetric manner into the first beam and the second beam with an equally-balanced power splitting ratio such that the first beam and the second beam are substantially equal in phase amplitude;
(c) a coiled polarization-maintaining optical fiber, which provides one single common optical path having two opposite ends respectively optically coupled to receive the first beam and the second beam from the polarization-maintaining 3×3 directional coupler, thereby allowing the first beam and the second beam to travel in opposite directions through the one single common optical path provided by the coiled polarization-maintaining optical fiber for observation and measurement of the Sagnac effect;
(d) a pair of photo detectors including a first photo detector and a second photo detector, which are optically coupled via the polarization-maintaining 3×3 directional coupler to respectively receive and optically sense the first beam and the second beam after exiting from the coiled polarization-maintaining optical fiber to thereby generate a pair of differential phase signals that indicate, in the event of a rotational movement, the angular speed of the rotational movement; and
(e) a third photo detector, connected to receive and optically sense the third beam from the polarization-maintaining 3×3 directional coupler, for generating a signal that indicates the power level of the third beam for automatic feedback control of the linearly-polarized light source in order to maintain the interrogating beam at a substantially fixed phase amplitude; wherein
the linearly-polarized light source, the polarization-maintaining 3×3 directional coupler, and the coiled polarization-maintaining optical fiber in combination constitute a polarization-maintaining mechanism that allows the interrogating beam as well as the first beam and the second beam to maintain linear polarization substantially all the way through the optical propagation path starting at the linearly-polarized light source and ending at the first photo detector and the second photo detector, thereby preventing polarization crosstalk between the first beam and the second beam for the purpose of eliminating and reducing common mode phase noises in the detected differential phase signals.

8. The fiber-optic gyroscope of claim 7, wherein in the case that the three waveguides of the polarization-maintaining 3×3 directional coupler are bundled in a linearly-juxtaposed formation, the symmetric beam-splitting configuration is implemented in such a manner that the center-most one of the three waveguides is chosen to serve as the main waveguide.

9. The fiber-optic gyroscope of claim 7, wherein in the case that the three waveguides of the polarization-maintaining 3×3 directional coupler are bundled in a triangular formation, the symmetric beam-splitting configuration is implemented in such a manner that an arbitrary one of the three waveguides is chosen to serve as the main waveguide.

10. The fiber-optic gyroscope of claim 7, wherein the coiled polarization-maintaining optical fiber is a stress-rod type, an elliptical-cladding type, or a bow-tie type.

11. The fiber-optic gyroscope of claim 7, further comprising:
a signal processing unit, connected to receive the pair of differential phase signals from the first photo detector and the second photo detector, for processing the pair of differential phase signals based on the principle of the Sagnac effect to thereby generate an output signal that indicates the angular velocity of the rotational movement.

12. A fiber-optic gyroscope, comprising:
(a) a linearly-polarized light source for generating a linearly-polarized light beam to serve as an interrogating beam;
(b) a polarization-maintaining 3×3 directional coupler having three waveguides including a main waveguide, a first branching waveguide, and a second branching waveguide, for splitting the interrogating beam into a first beam, a second beam, and a third beam; wherein the main waveguide is optically coupled to receive the interrogating beam from the linearly-polarized light source while the first branching waveguide and the second branching waveguide are respectively used to transmit the first beam and the second beam; and wherein the main waveguide, the first branching waveguide, and the second branching waveguide are arranged in a symmetric beam-splitting configuration in order to split the interrogating beam in a symmetric manner into the first beam and the second beam with an equally-balanced power splitting ratio such that the first beam and the second beam are substantially equal in phase amplitude;
(c) a coiled polarization-maintaining optical fiber, which provides one single common optical path having two opposite ends respectively optically coupled to receive the first beam and the second beam from the polarization-maintaining 3×3 directional coupler, thereby allowing the first beam and the second beam to travel in opposite directions through the one single common optical path provided by the coiled polarization-maintaining optical fiber for observation and measurement of the Sagnac effect; and
(d) a pair of photo detectors including a first photo detector and a second photo detector, which are optically coupled via the polarization-maintaining 3×3 directional coupler to respectively receive and optically sense the first beam and the second beam after exiting from the coiled polarization-maintaining optical fiber to thereby generate a pair of differential phase signals that indicate, in the event of a rotational movement, the angular speed of the rotational movement;
(e) a third photo detector, connected to receive and optically sense the third beam from the polarization-maintaining 3×3 directional coupler, for generating a signal that indicates the power level of the third beam for automatic feedback control of the linearly-polarized light source in order to maintain the interrogating beam at a substantially fixed phase amplitude; and
(f) a signal processing unit, connected to receive the pair of differential phase signals from the first photo detector and the second photo detector, for processing the pair of differential phase signals based on the principle of the Sagnac effect to thereby generate an output signal that indicates the angular velocity of the rotational movement; wherein
the linearly-polarized light source, the polarization-maintaining 3×3 directional coupler, and the coiled polarization-maintaining optical fiber in combination constitute a polarization-maintaining mechanism that allows the interrogating beam as well as the first beam and the second beam to maintain linear polarization substantially all the way through the optical propagation path starting at the linearly-polarized light source and ending at the first photo detector and the second photo detector, thereby preventing polarization crosstalk between the first beam and the second beam for the purpose of eliminating and reducing common mode phase noises in the detected differential phase signals.

13. The fiber-optic gyroscope of claim 12, wherein in the case that the three waveguides of the polarization-maintaining 3×3 directional coupler are bundled in a linearly juxtaposed formation, the symmetric beam-splitting configuration is implemented in such a manner that the center-most one of the three waveguides is chosen to serve as the main waveguide.

14. The fiber-optic gyroscope of claim 12, wherein in the case that the three waveguides of the polarization-maintaining 3×3 directional coupler are bundled in a triangular formation, the symmetric beam-splitting configuration is implemented in such a manner that an arbitrary one of the three waveguides is chosen to serve as the main waveguide.

15. The fiber-optic gyroscope of claim 12, wherein the coiled polarization-maintaining optical fiber is a stress-rod type, an elliptical-cladding type, or a bow-tie type.
